(19) United States
(12) Patent Application Publication
(10) Pub. No.: US 2020/0120310 A1
(43) Pub. Date: Apr. 16, 2020

(54) Multiple Functions LED Night Light

(71) Applicant: Tseng-Lu Chien, Walnut, CA (US)

(72) Inventor: Tseng-Lu Chien, Walnut, CA (US)

(21) Appl. No.: 16/710,276

(22) Filed: Dec. 11, 2019

Related U.S. Application Data
(63) Continuation-in-part of application No. 16/242,761, filed on Jan. 8, 2019.
Application No. 16/242,761 is a continuation-in-part of application No. 14/739,397, filed on Jun. 15, 2015, now Pat. No. 10,184,624.
Application No. 14/739,397 is a continuation of application No. 11/806,285, filed on May 31, 2007.
Application No. 11/806,285 is a continuation of application No. 11/498,874, filed on Aug. 4, 2006.
Application No. 11/498,874 is a continuation of application No. 10/954,189, filed on Oct. 1, 2004, now abandoned.
Application No. 10/954,189 is a continuation-in-part of application No. 16/285,631, filed on Feb. 26, 2019.
Application No. 16/285,631 is a continuation-in-part of application No. 16/298,110, filed on Mar. 11, 2019.
Application No. 16/298,110 is a continuation-in-part of application No. 11/498,874, filed on Aug. 4, 2006.
Application No. 11/498,874 is a continuation of application No. 10/954,189, filed on Oct. 1, 2004, now abandoned.
Application No. 14/739,397 is a continuation-in-part of application No. 11/806,284, filed on May 31, 2007, now Pat. No. 7,632,004.

(51) Int. Cl. H04N 7/18; H04N 5/76; H04N 5/247; H04N 5/235; H04N 5/225; F21V 33/00; H04N 5/232; G01S 3/786; F21S 8/00; F21S 4/28; F21V 29/00; F21V 23/04; F21V 21/14; F21V 21/08; F21V 14/02; F21S 10/00; F21S 9/02

(52) U.S. Cl. CPC H04N 7/181; F21V 19/006; H04N 5/247; H04N 5/2354; H04N 5/2257; H04N 5/2256; F21V 33/0052; H04N 5/23241; H04N 5/2252; G01S 3/7864; F21S 8/038; F21S 4/28; F21V 29/00; F21V 23/04; F21V 21/14; F21V 21/08; F21V 14/02; F21S 10/002; F21S 9/022; F21S 8/035; H04N 5/76

(57) ABSTRACT

A multiple function LED night light has at least one LED device with or without at least one additional function(s) such as an air-freshener adaptor device, sonic device, frequency device, sensor device, bug repeller device, second light device, timepiece, electric message device, timer device, temperature device, surge protection device, electric short circuit protection device, base device for installation on an existing lamp socket, emergency light device, or any other electric device(s) suitable for home use to keep people comfortable or safe. The LED device has a first optic element(s) to change the narrow-viewing angle of an LED's spot-light beams into a wider-viewing angle and second optic element(s) to help make the LED night light exhibit lighting effect without super bright lighted spot(s). Wherein element is at least one of optic lens(es) or reflective walls, exposed surface(s). The LED bulb has built-in AC-to-DC circuit may be arranged to fit into an existing night light bulb socket to upgrade any existing bulb night light into a power saving LED night light.

### RELATED U.S. PATENT DOCUMENTS

This application is a division of U.S. patent application Ser. No. 11/806,285 (hereafter as # R-2007), Ser. No. 11/806,284 (hereafter as Q-2007) both applications are filed May 31, 2007, and herein incorporated by reference.

This application is a division of

U.S. patent application Ser. No. 16/242,761, filed Jan. 8, 2019, (hereafter as # R-4)

Multiple function LED night light

This application is a division of

U.S. patent application Ser. No. 14/739,499, filed Jun. 15, 2015,

(hereafter as # R-3), now is U.S. Pat. No. 10,487,999 patented

Multiple function LED night light

This application is a division of

U.S. patent application Ser. No. 14/739,666, filed Jun. 15, 2015,

(hereafter as # R-2), now allowed

Multiple function LED night light

This application is a division of

U.S. patent application Ser. No. 14/739,397, filed Jun. 15, 2015,

(hereafter as # R-1), now is U.S. Pat. No. 10,184,624

Multiple function LED night light

now is U.S. Pat. No. 10,184,624 issued on Jan. 22, 2019

This application is a division of

U.S. patent application Ser. No. 11/806,285, filed May 31, 2007,

(hereafter as # R-07) (Still pending for over 12 years)

This application is a division of

U.S. patent application Ser. No. 11/806,284, filed May 31, 2007,

(hereafter as # Q-07) now U.S. Pat. No. 7,632,004

LED night light with more than one optics means

now is U.S. Pat. No. 7,632,004 issued on Dec. 15, 2009

This application is a continuation of

U.S. application Ser. No. 11/498,874 file don Aug. 4, 2006 (Still pending)

(hereafter as # K-06)

LED night light has area-illumination by multiple time reflection and refraction 20

This application is a continuation of

U.S. application Ser. No. 10/954,189 filed on Oct. 1, 2004.

This application is a continuation of

U.S. patent application Ser. No. 11/527,628, filed Sep. 27, 2006,

(hereafter as # M-06)

multiple functions LED night light with air freshener

now is U.S. Pat. No. 7,611,253 issue on Nov. 3, 2009,

This application is a continuation of

U.S. patent application Ser. No. 11/527,629, filed Sep. 27, 2006,

(hereafter # L) now U.S. Pat. No. 8,545,090

LED night light with changeable display unit

now is U.S. Pat. No. 8,545,090 issue on Oct. 1, 2013,

This application is a continuation of

U.S. patent application Ser. No. 14/252,102, filed Apr. 14, 2014,

(hereafter as # J-6) now is U.S. Pat. No. 9,128,692

LED night light with time piece

now is U.S. Pat. No. 9,128,692 issue on Sep. 8, 2015,

This application is a continuation of

(# J5) now is U.S. Pat. No. 8,811,122

LED night light with time piece

U.S. patent application Ser. No. 13/428,086, filed Mar. 23, 2012,

now is U.S. Pat. No. 8,811,122 issue on Aug. 19, 2014,

This application is a continuation of

U.S. patent application Ser. No. 12/894,782, filed Sep. 30, 2010,

(hereafter as # J-4) now is U.S. Pat. No. 8,289,814

LED night light with time piece

now is U.S. Pat. No. 8,289,814 issue on Oct. 16, 2012,

This application is a continuation of

U.S. patent application Ser. No. 12/545,922, filed Aug. 24, 2009,

(hereafter as # J-3) now is U.S. Pat. No. 8,164,984

LED night light with time piece

now is U.S. Pat. No. 8,164,984 issue on Apr. 24, 2012,

This application is a continuation of U.S. patent application Ser. No. 11/498,881, filed Aug. 4, 2006,

(hereafter as #1-2006) U.S. Pat. No. 7,568,829

poly night light

now is U.S. Pat. No. 7,568,829 issue on Aug. 4, 2009,

This application is a continuation of

U.S. patent application Ser. No. 12/546,012, filed Aug. 24, 2009,

(hereafter as # H-1) U.S. Pat. No. 8,029,182

multiple light source night light

now is U.S. Pat. No. 8,029,182 issue on Oct. 4, 201,

which is a continuation of

U.S. patent application Ser. No. 11/255,981, filed Oct. 24, 2005,

(hereafter as # H-2005) U.S. Pat. No. 7,455,444

Multiple light source Night light

now is U.S. Pat. No. 7,455,444 issued on Nov. 25, 2008

which is CIP of

U.S. application Ser. No. 11/094,215 filed on Mar. 31, 2005

(hereafter as # E-2005) U.S. Pat. No. 7,909,477

LED night light with liquid optics medium

now is U.S. Pat. No. 7,909,477 issue on Mar. 22, 2011,

which is CIP of

U.S. application Ser. No. 11/092,742 filed on May 30, 2005

(hereafter as # D-2005) U.S. Pat. No. 7,997,785

Linear tube night light with changeable patterns

now is U.S. Pat. No. 7,997,785 issue on Aug. 16, 2011,

which is CIP of

U.S. application Ser. No. 11/092,741 filed on May 30, 2005

(hereafter as # C-2005) U.S. Pat. No. 7,232,251

Night light with Fiber Optics

now is U.S. Pat. No. 7,232,251 issue on Jun. 19, 2007,

which is CIP of

U.S. application Ser. No. 11/094,156 filed on May 31, 2005

(hereafter as # B-2005) U.S. Pat. No. 7,318,653

Multiple Function wall cover plate

now is U.S. Pat. No. 7,318,653 issue on Jan. 15, 2008,

which is CIP of

U.S. application Ser. No. 11/094,155 filed on Mar. 31, 2005

(hereafter as # A-2005) U.S. Pat. No. 7,810,985

Multiple function EL night light

now is U.S. Pat. No. 7,810,985 issue on Oct. 12, 2010,

The current invention also is continuously filing of U.S. application Ser. No. 14/817,675 filed on Aug. 4, 2015

(hereafter as # VVV-1)

Multiple function night light has built-in USB and light means

Which is continuously filing of

U.S. application Ser. No. 13/910,295 filed on Jun. 5, 2013

(hereafter as # VVV)

Multiple function night light has built-in USB and light means

Which is continuously filing of

U.S. application Ser. No. 13/858,604 filed on Apr. 8, 2013

(hereafter as # RRR)

Which is continuously filing of

U.S. application Ser. No. 13/117,227 filed on May 27, 2011

(hereafter as # FFF)

Universal module has USB-unit or/and outlet-unit(s) for variety of electric or digital data device(s)

Which is CIP of Ser. No. 12/894,782 filed on Sep. 30, 2010,

(hereafter as # J4)

Which is CIP of Ser. No. 12/502,661 filed on Jul. 14, 2009

Which is CIP of Ser. No. 12/292,580 filed on Nov. 21, 2008

(hereafter as # J-2)

Which is CIP of Ser. No. 12/566,322 filed on Sep. 24, 2009

Which is CIP of Ser. No. 11/498,874 filed on Aug. 4, 2006,

(hereafter as # K)

Which is CIP of Ser. No. 11/527,627 filed on Sep. 27, 2006,

Which is CIP of Ser. No. 12/622,000 filed on Nov. 19, 2009,

(hereafter as # L)

Which is CIP of Ser. No. 12/624,621 filed on Nov. 24, 2009,

And current invention also is Continuous filing of

U.S. application Ser. No. 12/914,584 filed on Oct. 28, 2010,

Div. of Ser. No. 12/318,470 filed on Dec. 30, 2008, May 13, 2014 issues.

(hereafter as # FF-1) “LED project Night Light” now is U.S. Pat. No. 8,721,160

Which is CIP of

U.S. application Ser. No. 12/073,889 filed on Mar. 11, 2008, (hereafter as # X) LED light with changeable LED position with preferable power source

now is U.S. Pat. No. 8,827,511 issued on Sep. 9, 2014

Which is CIP of

U.S. application Ser. No. 11/527,629 filed Sep. 27, 2006,

(hereafter as # L) “LED night light with interchangeable display unit” now is U.S. Pat. No. 8,545,090 issued Oct. 1, 131

Which is CIP of

U.S. application Ser. No. 12/894,865 filed on Sep. 30, 2010

(hereafter as # T-1) LED light device with changeable features now is U.S. Pat. No. 8,393,755 issued Mar. 12, 2013

Which is CIP of

(# J-5) “Time piece with LED night light” now is U.S. Pat. No. 8,811,122

Which is CIP of

U.S. application Ser. No. 13/428,086 filed Mar. 23, 2012, Aug. 19, 2014 issued.

Which is CIP

U.S. application Ser. No. 12/292,580 filed on Nov. 21, 2008 U.S. Pat. No. 8,305,846

Which is CIP U.S. application Ser. No. 11/527,631 filed Sep. 27, 2006.

Which is CIP of

U.S. application Ser. No. 12/894,782 filed Sep. 30, 2010,

(hereafter as # J-4) “Time Piece with LED night light” now is U.S. Pat. No. 8,289,814

Which is CIP of

U.S. application Ser. No. 12/545,992 filed Aug. 24, 2009,

Which is

CIP of U.S. application Ser. No. 12/292,580 filed on Nov. 21, 2008,

Which is

CIP of U.S. application Ser. No. 11/527,631 filed Sep. 27, 2006.

Which is CIP of

U.S. application Ser. No. 12/292,580 filed Nov. 21, 2008,

(hereafter as # J-2) “Time piece with LED night light” now is U.S. Pat. No. 8,305,846

Which is CIP of

U.S. application Ser. No. 11/527,631 filed Sep. 27, 2006

### BACKGROUND

This application is a division of U.S. patent application Ser. No. 11/806,285 (hereafter as # R-2007), Ser. No. 11/806,284 (hereafter as Q-2007) both applications are filed May 31, 2007, and herein incorporated by reference.

This application is a division of

U.S. patent application Ser. No. 16/242,761, filed Jan. 8, 2019, (hereafter as # R-4)

Multiple function LED night light

This application is a division of

U.S. patent application Ser. No. 14/739,499, filed Jun. 15, 2015,

(hereafter as # R-3), now is U.S. Pat. No. 10,487,999 patented

Multiple function LED night light

This application is a division of

U.S. patent application Ser. No. 14/739,666, filed Jun. 15, 2015,

(hereafter as # R-2), now allowed

Multiple function LED night light

This application is a division of

U.S. patent application Ser. No. 14/739,397, filed Jun. 15, 2015,

(hereafter as # R-1), now is U.S. Pat. No. 10,184,624

Multiple function LED night light

now is U.S. Pat. No. 10,184,624 issued on Jan. 22, 2019

This application is a division of

U.S. patent application Ser. No. 11/806,285, filed May 31, 2007,

(hereafter as # R-07) (Still pending for over 12 years)

This application is a division of

U.S. patent application Ser. No. 11/806,284, filed May 31, 2007,

(hereafter as # Q-07) now U.S. Pat. No. 7,632,004

LED night light with more than one optics means

now is U.S. Pat. No. 7,632,004 issued on Dec. 15, 2009

This application is a continuation of

U.S. application Ser. No. 11/498,874 file don Aug. 4, 2006 (Still pending)

(hereafter as # K-06)

LED night light has area-illumination by multiple time reflection and refraction 20

This application is a continuation of

U.S. application Ser. No. 10/954,189 filed on Oct. 1, 2004.

This application is a continuation of

U.S. patent application Ser. No. 11/527,628, filed Sep. 27, 2006,

(hereafter as # M-06)

multiple functions LED night light with air freshener

now is U.S. Pat. No. 7,611,253 issue on Nov. 3, 2009,

This application is a continuation of

U.S. patent application Ser. No. 11/527,629, filed Sep. 27, 2006,

(hereafter # L) now U.S. Pat. No. 8,545,090

LED night light with changeable display unit

now is U.S. Pat. No. 8,545,090 issue on Oct. 1, 2013,

This application is a continuation of

U.S. patent application Ser. No. 14/252,102, filed Apr. 14, 2014,

(hereafter as # J-6) now is U.S. Pat. No. 9,128,692

LED night light with time piece

now is U.S. Pat. No. 9,128,692 issue on Sep. 8, 2015,

This application is a continuation of (# J5) now is U.S. Pat. No. 8,811,122

LED night light with time piece

U.S. patent application Ser. No. 13/428,086, filed Mar. 23, 2012, now is U.S. Pat. No. 8,811,122 issue on Aug. 19, 2014,

This application is a continuation of

U.S. patent application Ser. No. 12/894,782, filed Sep. 30, 2010,

(hereafter as # J-4) now is U.S. Pat. No. 8,289,814

LED night light with time piece

now is U.S. Pat. No. 8,289,814 issue on Oct. 16, 2012,

This application is a continuation of

U.S. patent application Ser. No. 12/545,922, filed Aug. 24, 2009,

(hereafter as # J-3) now is U.S. Pat. No. 8,164,984

LED night light with time piece

now is U.S. Pat. No. 8,164,984 issue on Apr. 24, 2012,

This application is a continuation of U.S. patent application Ser. No. 11/498,881, filed Aug. 4, 2006,

(hereafter as #1-2006) U.S. Pat. No. 7,568,829

poly night light

now is U.S. Pat. No. 7,568,829 issue on Aug. 4, 2009,

This application is a continuation of

U.S. patent application Ser. No. 12/546,012, filed Aug. 24, 2009,

(hereafter as # H-1) U.S. Pat. No. 8,029,182

multiple light source night light

now is U.S. Pat. No. 8,029,182 issue on Oct. 4, 201,

which is a continuation of

U.S. patent application Ser. No. 11/255,981, filed Oct. 24, 2005, (hereafter as # H-2005)

U.S. Pat. No. 7,455,444

Multiple light source Night light

now is U.S. Pat. No. 7,455,444 issued on Nov. 25, 2008

which is CIP of

U.S. application Ser. No. 11/094,215 filed on Mar. 31, 2005

(hereafter as # E-2005) U.S. Pat. No. 7,909,477

LED night light with liquid optics medium

now is U.S. Pat. No. 7,909,477 issue on Mar. 22, 2011,

which is CIP of

U.S. application Ser. No. 11/092,742 filed on May 30, 2005

(hereafter as # D-2005) U.S. Pat. No. 7,997,785

Linear tube night light with changeable patterns

now is U.S. Pat. No. 7,997,785 issue on Aug. 16, 2011,

which is CIP of

U.S. application Ser. No. 11/092,741 filed on May 30, 2005

(hereafter as # C-2005) U.S. Pat. No. 7,232,251

Night light with Fiber Optics

now is U.S. Pat. No. 7,232,251 issue on Jun. 19, 2007,

which is CIP of

U.S. application Ser. No. 11/094,156 filed on May 31, 2005

(hereafter as # B-2005) U.S. Pat. No. 7,318,653

Multiple Function wall cover plate

now is U.S. Pat. No. 7,318,653 issue on Jan. 15, 2008,

which is CIP of

U.S. application Ser. No. 11/094,155 filed on Mar. 31, 2005

(hereafter as # A-2005) U.S. Pat. No. 7,810,985

Multiple function EL night light

now is U.S. Pat. No. 7,810,985 issue on Oct. 12, 2010,

The current invention also is continuously filing of U.S. application Ser. No. 14/817,675 filed on Aug. 4, 2015

(hereafter as # VVV-1)

Multiple function night light has built-in USB and light means

Which is continuously filing of

U.S. application Ser. No. 13/910,295 filed on Jun. 5, 2013

(hereafter as # VVV)

Multiple function night light has built-in USB and light means

Which is continuously filing of

U.S. application Ser. No. 13/858,604 filed on Apr. 8, 2013

(hereafter as # RRR)

Which is continuously filing of

U.S. application Ser. No. 13/117,227 filed on May 27, 2011

(hereafter as # FFF)

Universal module has USB-unit or/and outlet-unit(s) for variety of electric or digital data device(s)

Which is CIP of Ser. No. 12/894,782 filed on Sep. 30, 2010,

(hereafter as # J4)

Which is CIP of Ser. No. 12/502,661 filed on Jul. 14, 2009

Which is CIP of Ser. No. 12/292,580 filed on Nov. 21, 2008

(hereafter as # J-2)

Which is CIP of Ser. No. 12/566,322 filed on Sep. 24, 2009

Which is CIP of Ser. No. 11/498,874 filed on Aug. 4, 2006,

(hereafter as # K)

Which is CIP of Ser. No. 11/527,627 filed on Sep. 27, 2006,

Which is CIP of Ser. No. 12/622,000 filed on Nov. 19, 2009,

(hereafter as # L)

Which is CIP of Ser. No. 12/624,621 filed on Nov. 24, 2009,

And current invention also is Continuous filing of

U.S. application Ser. No. 12/914,584 filed on Oct. 28, 2010,

Div. of Ser. No. 12/318,470 filed on Dec. 30, 2008, May 13, 2014 issues.

(hereafter as # FF-1) “LED project Night Light” now is U.S. Pat. No. 8,721,160

Which is CIP of

U.S. application Ser. No. 12/073,889 filed on Mar. 11, 2008, (hereafter as # X) LED light

with changeable LED position with preferable power source

now is U.S. Pat. No. 8,827,511 issued on Sep. 9, 2014

Which is CIP of

U.S. application Ser. No. 11/527,629 filed Sep. 27, 2006,

(hereafter as # L) “LED night light with interchangeable display unit” now is U.S. Pat. No. 8,545,090 issued Oct. 1, 131

Which is CIP of

U.S. application Ser. No. 12/894,865 filed on Sep. 30, 2010

(hereafter as # T-1) LED light device with changeable features now is U.S. Pat. No. 8,393,755 issued Mar. 12, 2013

Which is CIP of

(# J-5) “Time piece with LED night light” now is U.S. Pat. No. 8,811,122

Which is CIP of

U.S. application Ser. No. 13-428, 086 filed Mar. 23, 2012, Aug. 19, 2014 issued.

Which is CIP

U.S. application Ser. No. 12/292,580 filed on Nov. 21, 2008 U.S. Pat. No. 8,305,846

Which is CIP U.S. application Ser. No. 11/527,631 filed Sep. 27, 2006.

Which is CIP of

U.S. application Ser. No. 12/894,782 filed Sep. 30, 2010,

(hereafter as # J-4) “Time Piece with LED night light” now is U.S. Pat. No. 8,289,814

Which is CIP of

U.S. application Ser. No. 12/545,992 filed Aug. 24, 2009,

Which is

CIP of U.S. application Ser. No. 12/292,580 filed on Nov. 21, 2008,

Which is

CIP of U.S. application Ser. No. 11/527,631 filed Sep. 27, 2006.

Wich is CIP of

U.S. application Ser. No. 12/292,580 filed Nov. 21, 2008,

(hereafter as # J-2) “Time piece with LED night light” now is U.S. Pat. No. 8,305,846

Which is CIP of

U.S. application Ser. No. 11/527,631 filed Sep. 27, 2006

The following co-pending U.S. patent applications by the same Inventor also are directed to night lights: Ser. No. 10/883,747, filed Jul. 6, 2004; Ser. No. 11/092,741; Ser. No. 11/094,215; Ser. No. 11/255,981; Ser. No. 11/498,881; Ser. No. 11/527,631; Ser. No. 11/498,874; Ser. No. 11/527,629; and Ser. No. 11/527,628.

In addition, the Inventor's U.S. Pat. Nos. 5,926,440; 6,158,868; 6,170,958; 6,171,117; 6,280,053 disclose arrangements of conductive means for night lights and multiple function night lights incorporated time pieces. Other U.S. Pat. Nos. 4,947,291; 5,495,402; 5,662,408; 5,713,655; 5,803,579; 5,816,682; 5,833,350; 5,893,626; 5,998,928; 6,000,807; 6,010,228; 6,031,958; 6,033,087; 6,056,420; 6,132,072; 6,160,948; 6,161,910; 6,183,101; 6,190,017; 6,290,368; 6,337,946; 6,386,730; 6,390,647; 6,00,104; 6,411,524; 6,431,719; 6,509,832; 6,523,976; 6,550,949; 6,609,812; 6,623,416; 6,641,289; 6,648,496; and 6,709,126 all show different light sources and applications but none teaches an LED night light having multiple functions which may be selected from the group including an adaptor device, fan device, heat device, bug repeller device, sonic device, frequency device, or any other home electric appliance or device suitable for adding onto an LED night light.

The current invention offers a big improvement in power saving because it incorporates the low power consumption Light Emitting Diode (LED) to replace the incandescent bulb which normally uses a 4 Watt or 7 Watt or more power consumption light means. A single LED normally has a 0.3 Watt+/−100% power consumption depending on the product design and illumination needed.

The current invention not only provides a power saving device but also reduces a consumer's monthly electricity expense. The current invention also supplies two or more additional practical functions to the consumer, which may selected from, for example, an air-freshener and/or (as described in co-pending U.S. patent application Ser. Nos. 11/527,631; 11/527,629; 11/498,881; 11/498,874; and Ser. No. 11/527,628; etc.) an adaptor device, sonic device, frequency device, bug repeller device, second light device, timepiece, electric message device, timer device, temperature device, surge protection device, electric short circuit protection device, base device for installation on an existing lamp socket, emergency light device, or any other electric device(s) used in a home to keep people comfortable or safe.

This current invention optionally may further incorporate the teachings of the co-pending application entitled “LED night light with more than one optics means” concerning the inclusion in the LED night light of an optical element that improves the visibility of light beams from the LED.

All existing LED nightlights have the big problem that the LED unit can be seen by a viewer over a narrow viewing angle only, and that the brightness over that angle is too strong, resulting in spot-light effects (super bright in a small area). The co-pending application teaches multiple (more than one) optics means to provide a big improvement from spot light to linear or area brightness, thereby causing the spot-light effects to change to a nice looking lighting effect such as that provided by a fluorescent tube. It is very difficult to use only one piece of optics means to cause the strong spot-light LED unit(s) to have nice and warm light effects that can be seen by a viewer. This is a big improvement in the LED night light.

The current invention further adds some other arrangement such as reflector(s), bubble(s), or lens(es) within any of the optics element(s) or optic-lens to increase the effects of modifying the narrow viewing angle light beams emitted out of the LED(s) to provide linear or area light effects.

Furthermore, the current LED night light invention solves several problems with the most popular night light in the marketplace. The most popular night light length is around 88 mm+/−50 mm (with base), The outer optics-lens or optical elements or expose wall height is around 60 mm+/−30 mm (without base). The height from the wall outlet cover is around 35 mm+/−15 mm (from outlet cover surface). If the LED unit is placed on the same location as the outlet cover surface, the distance from the wall to the outside of the optics-lens or optical elements or expose wall will be less than 35 mm+/−15 mm, which is too short to eliminate the spot-light LED's into a surface or area photometric or lighted area having illumination without super bright spot(s)-light. The problem is solved by using two optics-lens or optic-element(s) or-and exposed wall(s) to get a good surface or area lighting effect with super bright lighted spot(s) or even brightness performance on the outer optics-lens, or exposed wall or optical-element(s). In addition, the LED night light power consumption will fall within the 0.3 W+/−100% per LED range, whereas the power consumption of a bulb night light falls within 4 Watt+/−50% per bulb. So, the LED night light will have a big power saving and reduce the monthly electric bill for the consumer.

The current invention not only provides a simple multiple function LED night light, but also provides excellent light performance. The LED night light with more than one function can add any function selected from, by way of example, an adaptor device, motion sensor device, PIR sensor device, air freshener, second light device, bug repellent device, sonic repellent device, surge protection device, emergency light device, time device, timer device, or any combination so the LED night light can be have nice light performance with more than single functions.

### BRIEF DRAWINGS

FIGS. 1-4 are perspective views taken from different viewing angles showing a first preferred embodiment of a multiple function of LED night light.

FIG. 5 is a partially cut-away front view showing construction details of the preferred embodiment illustrated in FIGS. 1-4.

FIGS. 6-10 are perspective views at different viewing angles of a second preferred embodiment of a multiple function LED night light.

FIG. 11 is a perspective view of third preferred embodiment of a multiple function of LED light.

FIG. 12 is a perspective view of a fourth preferred embodiment of a multiple function LED light.

FIG. 13 is a perspective view of a fifth preferred embodiment of a multiple function of LED light with a base device for installation on an existing lamp socket.

FIG. 14 show the (# Q-07) Parent filing case for (# FF-4) (# FF-3) (# FF-2) (# FF-1) and (# II-2009) (# II-II) is the (# Q-07) as above discussed so not discuss more details here. Which also is parent filed case of (# R-2007) which is filed on same date of (# Q-2007) which is parent of division filed cases of (# R-1) (# R-2) (# R-3) (# R-4) (# R-5) (# R-6). From FIG. 14 show the background discussed the co-pending case (# R-6) (# R-5) (# R-4) (# R-2) (# R-2007) for LED night light has more than one optical element(s) as drawing FIG. 14 show details abstract which has 1^{st} (31) and 2^{nd} (30) optics-element(s). Where the said 1^{st} (31) optic-element(s) have at least one function(s) select from (i) to eliminate the at least one LED(s) (36) super brightness spot-light(s) to none super brightness spot-light(s) or very close even brightness, (ii) prevent people from touch LED(s) (31) or inner electric parts (34) on PCB, (3) allow the LED(s) light beam to passing through.

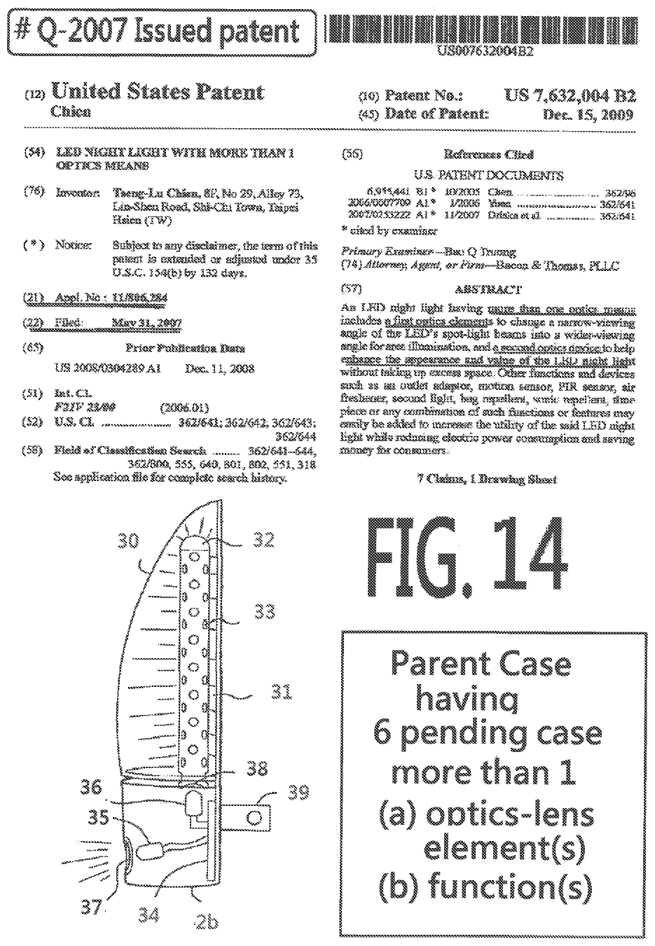

One of preferred embodiment, from FIG. 14 show the 1^{st} optics-element or optics-lens is one of tube construction. It is appreciated the 1^{st} optic-lens can be any construction such as dome (short of tube (30)), cone (sharp top of tube (30)), partial circle (half of tube (33)), curved piece (less than ½ tube (30)), flat piece; with or without air-bubble (33), reflectors (33), reflective, refractive, reflective and refractive optics-properties.

One of preferred embodiment, from FIG. 14 show the 2^{nd} optics-element or 2^{nd} optic-lens or 2^{nd} outer piece is one of detachable, separated piece which at least lack of one of (i) rear housing, (ii) side housing, (iii) rear and all sides housing; with or without at least one of (aa) U-shape or other-shape opening, (bb) built-in or add-on clipper, (cc) geometric shape clipper to clip-on or push-tight or assembled with base (2b) neck or groove or ditch (38).

One of preferred embodiment, from FIG. 14 show the said LED night light has built-in at least one of 2^{nd} LED(s) or more LED(s) to create at least one preferred light functions or performance for examples (i) color changing, (ii) color selection, (iii) brightness adjustable, (iv) fade-in or fade-out, or (v) other LED light function(s) or effect(s) available from marketplace while incorporate with at least one of (aaa) sensor (37), (bbb) IC on PCB, (ccc) switch(s), (ddd) wireless controller, (eee) slide switch.

From FIG. 14 also disclosure the said LED night light have at least one of additional functions, or features select from

(additional 1) outlet(s), or female receiving end(s), or terminal(s), or output(s), or port(s). as co-pending (# R-2007 U.S. patent Ser. No. 11/806,285 filed on May 31, 2007 same date of FIG. 30 which is (# Q-2007)).

(additional 2) motion/radar/photo/CDS sensor,

(additional 3) PIR sensor,

(additional 4) Air Freshener

(additional 5) second LED light or color LED light for area(s) or status indicator illumination.

(additional 6) bug repellent,

(additional 7) sonic repellent,

(additional 8) time piece,

(additional 9) supply AC or DC power device through outlet(s) or charger system(s)

(additional 9) any electric function(s) or features(s) combination from marketplace

### DETAILED DESCRIPTION

This application is Division of U.S. patent application Ser. No. 11/806,285 (hereafter as # R-2007), Ser. No. 11/806,284 (hereafter as Q-2007) both applications are filed May 31, 2007, and herein incorporated by reference.

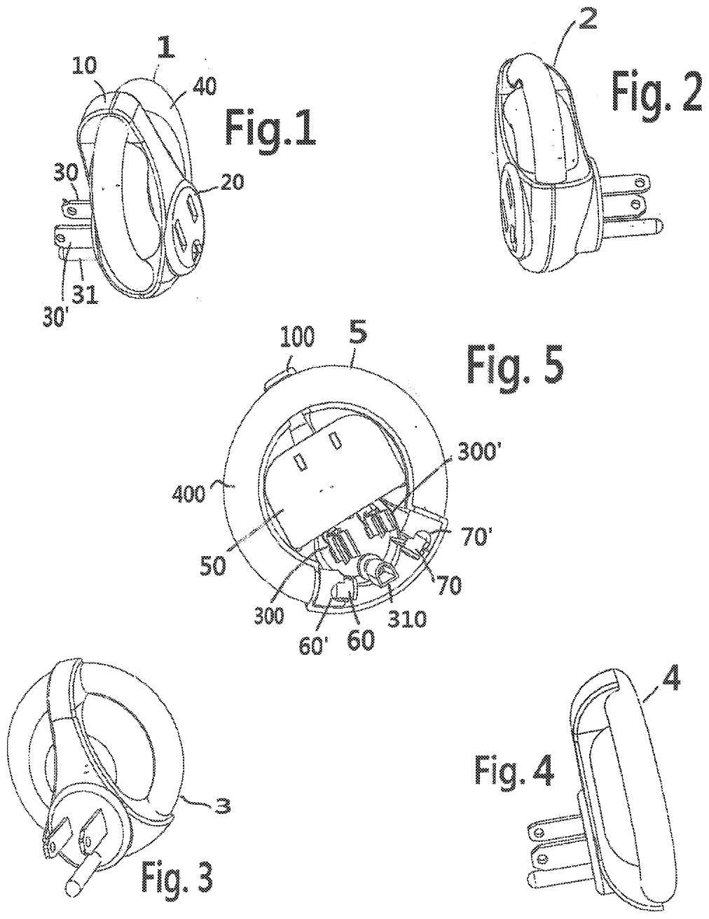

FIG. 1 shows a first preferred embodiment of a multiple functions LED night light in which the added function is adaptor device. The added function(s) may alternatively be selected from the devices described in co-pending U.S. patent application Ser. Nos. 11/527,631; 11/527,629; 11/498,881; 11/498,874; and 11/527,628 etc.), such as an air freshener, adaptor device, sonic device, frequency device, bug repeller device, second light device, timepiece, electric message device, timer device, temperature device, surge protection device, electric short circuit protection device, base device for installation on an existing lamp socket, emergency light device, or any other electric device(s) suitable for home use to keep people comfortable or safe. The added function(s) may be one to N (any number) to make a very practical multiple functions LED night light.

As shown in FIG. 1, the multiple function LED night light (1) has a back housing (10) assembled with a front housing (20) and arranged to capture prong means (30) (30′) (31) within and enable delivery of electricity from the outlet power source to the other electric appliance device. An optics means (40) exhibits light effects from the inner LED or LEDs to provide a light performance having predetermined functions, time, duration and so forth as required.

FIGS. 2-4 show the multiple function LED night light of FIG. 1 from different viewing angles. Fig. shows details of the inner construction of the multiple function LED night light (5) which has a back housing (100) and which holds an optics medium (400) having a ring design which is adjacent a circuit board (50) connected to prong means (300) (300′) to deliver input home electricity to the LEDs (60) (70) and cause the LEDs (60) (70) to emit a light beam into the optics means (400) from the two input ends (60′) and (70′). The preferred input ends are “U” shaped so as to allow as many of the light beams emitted from the LEDs (60) (70) to enter the optics means as possible. Some applications may have other designs for the optics means' input ends, which is not a limitation for the current invention's preferred embodiment description. The input ends design can be any type which is still within the current invention scope. The prong means (310) is a grounded type to provide more safety for the adaptor device. This prong arrangement can be varied depending on the different requirements of safety authorities or governments.

The optics means of FIG. 5 may have different arrangements that use sand-blasting to make the surface very rough and allow all the light to travel within without excess leakage, or use a plurality of the air-bubbles (or equivalent reflectors) inside the optics medium to cause light beams from the LEDs to exit the optics medium with splendid bright spots showing along the length of the medium.

As shown in FIG. 5, the circuit (50) may incorporate desired electric components selected from the group including, alone or in combination, at least one resistor, capacitor, switch means, sensor means, diode, inductor, transformer, integrated circuit (hereafter as IC), or any available components suitable for electrically driving LED(s) to have predetermined functions, duration, time, effects, and/or brightness.
The appropriate conductive piece used for the electric connection to the prong means (300) (300′) (310) and LEDs (60) (70). can be obtained from the marketplace and may include electric wires, and/or a harness, cable, spring, metal piece, or other conductive means without departing from the scope of the invention, as long as an electric signal can be delivered from the circuit (50) to the prong means and LEDs means.

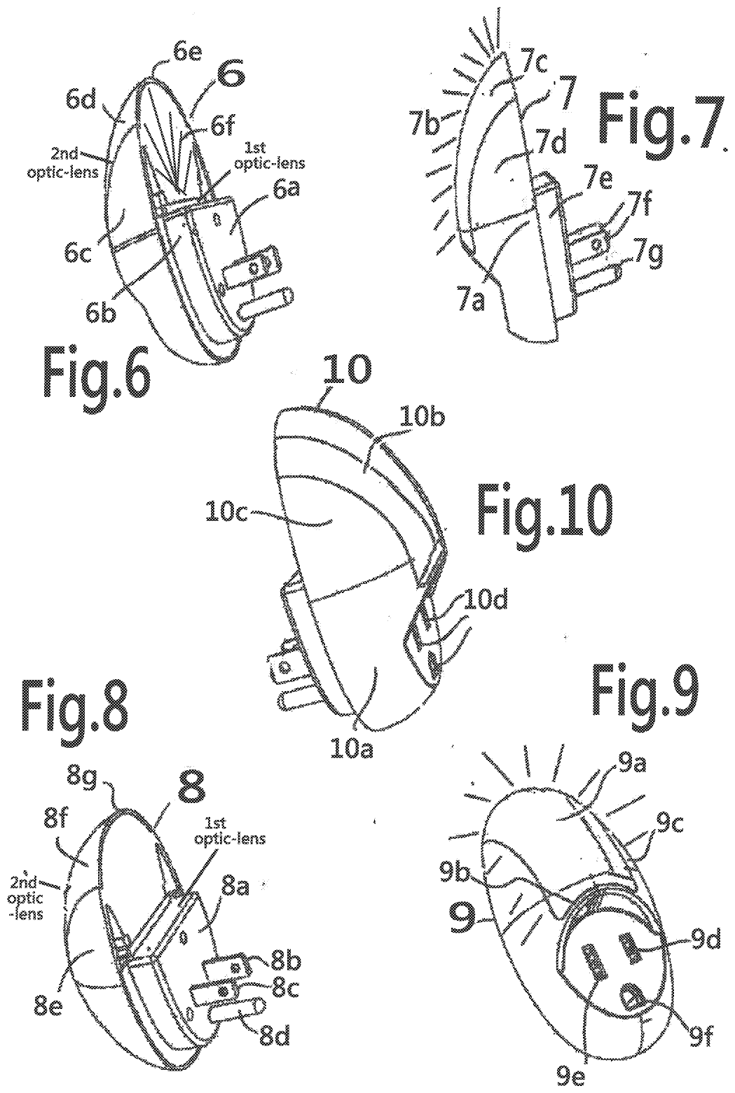

FIGS. 6-10 show the same features as FIGS. 1-5, the only difference being the different housing and optic-lens design with different space to arrange the LEDs, prong, circuit, and added device(s) on the LED night light.

From FIG. 6, The said LED light has base (6a) has circuitry inside to change AC current from outlet into desired current for inner LED or LED(s) light source(s) to tum-on and tum-off with desired functions. The LED or LED(s) light-beam emit to the 2^{nd} preferred optic-lens or optics-element (6d) (6c) which has same or different treatment(s) to make the narrow emit-angle LED or LED(s) light beam to spread out to whole or big-size surface of the said optics-lens (6d) or optics-element (6c) and the different with optics-lens (400) at the shape and inner construction.

The said FIG. 5 is solid and circle or donut or arc shape and is solid-piece without any hollow-inside or space-inside to add parts inside and optic-lens (400) emit light from whole body or length to let people see the illumination for big-area(s) not the ends. The optics-lens (6c) and (6d) same as the FIG. 5 the lens surface has desired treatment including same as FIG. 5 sand-blaster or other textures or marking or reflective surface(s) to make the narrow emit-out LED light beams to passing through or reflected or had tube on top with extra-piece to make the light-beam to be seem on whole surface of the optics-lens (400) or (6c) (6d).

From the FIG. 6 optics-lens (6c) or (6d) is not a solid tubular piece and it is a slim curve piece to save plastic expensive cost but can spread-out LED light-beam to whole or big-size surface. From FIG. 6 can see LED narrow emit-out light beam through the optics-lens (6c) (6d) spread out to wider areas as FIG. 7 (7b).

From FIG. 8 show the optics-lens (8g) is one of even-thickness for substrate and has preferred textures or marking or optics-designs (not shown but same FIG. 5 optics-lens (400) has sand-blaster or treatment) on the one or two surface of the optics-lens (8f)(8e) substrates (8g).

From the FIG. 9 show the Big recess area illumination (9a) which change from the narrow emit-out LED light beam while light beam passing through the front the 1^{st} optics-lens (9b) or-and emit to recess 2^{nd} optic element (9a) or-and side wall(s) (9c) to become wider spread-out light-beam to make wider-area can see the recess area (9a) illumination. The said added function or-and 2^{nd} electric-functions can like the ports (9d) (9e) or adaptor-hole (9f) which also can be 3 female prongs receiving outlets (same as FIG. 1 to FIG. 5) to allow other electric-device 3 male-prongs to insert as FIG. 1 to FIG. 5 shown.

The said ports (9d) (9e) or adaptor-hole (9f) also can be any other 2^{nd} functions as above discussed (i) to (xv) 15 preferred type of the 2^{nd} electric functions. From FIG. 10 show the preferred embodiment has recess 2^{nd} optic elements surface(s) (10b) (10c) which has desired texture or polished or smooth treatment, optics-design to make desired recess areas has illumination from inner LED or LED(s) in any type and combination with desired circuitry to make desired light-show.

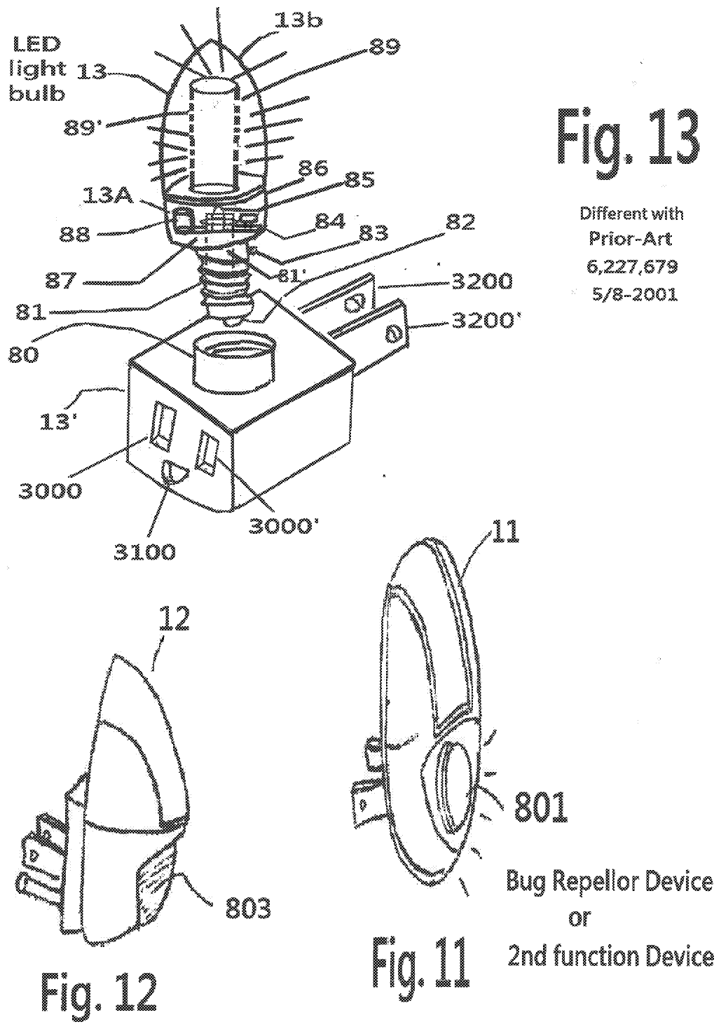

FIG. 11 shows a multiple function LED night light, in which the added function (801) can be selected from the group including any combination, as disclosed in co-pending U.S. patent application Ser. Nos. 11/527,631; 11/527,629; 11/498,881; 11/498,874; and 11/527,628 etc., of an air freshener, adaptor device, sonic device, frequency device, bug repeller device, second light device, timepiece, electric message device, timer device, temperature device, surge protection device, electric short circuit protection device, base device for installation on an existing lamp socket, emergency light device, or any other electric device(s) suitable for home use to keep people comfortable or safe. FIG. 12 also shows a multiple function LED night light whose added functions can be selected from the above listed functions.

FIG. 13 shows a multiple function LED night light in which a special LED bulb (13) is included in the existing multiple function bulb night light housing with added function (13′). The multiple function LED night light of FIG. 13 has at least one LED device installed on a geometric base that also has the added electric, mechanical, or chemical function. The base also has a bulb socket to accept the conventional bulb base, which may select from a screw type, pin type, rivet type, or knob type. The LED device has built-in circuit means to change the bulb's electric signal to an LED's electric signal so as to turn on the LED(s) to exhibit predetermined function, duration, time, and/or brightness and light effects.

As shown in FIG. 13, the base (13′) has a bulb socket (80) and added adaptor function provided by the adaptor receptacles (3000) (3000′) (3100), which offer electricity to other electric appliances while the prong means (3200) (3200′) are connected to the wall outlet. At the same time, while prong means (3200) (3200′) are connected with the wall outlet power source, the bulb socket (80) also will receive the wall outlet power source electric signal, which in the USA is around 110 Volt, 60 Hz, to turn on the bulb inserted into the base. On the other hand, specially designed LED device (13) has a built-in circuit to change the wall outlet power source of 110V AC, 60 Hz to the working voltage and frequency of the LED(s) with desired control means such as a photo sensor, PIR sensor, manual switch, or other control means available in the marketplace to turn on LED(s) according to pre-determined functions, brightness, duration, and time.

The LED device (13) that fits into the bulb socket (80) has a base type (81) which may be but is not limited to a screw type base as shown in FIG. 13. The bulb base (81) has two electric terminals (83) and (82) to connect with electric signal electrodes through an inner lamp holder (not shown) which is connected with a prong means (3200) (3200′). The electric signal from the two electric terminals (83) and (82) is supplied to the circuit board (81′), which changes the electric signal from home appliance electric current to LED working current and turns on the LED (85) for single color or multiple colors to provide a desired light performance. The LED (85) is located on the side of the circuit board (81′) and connected with the bulb base electric terminals (82) (83) by conventional conductive means in circuit board (81′). The electric components (88) (85) may be installed on the circuit board (81′) or connected by conductive means (87) (84) away from the circuit board (81′) because some components may be too big and unable to fit within the bulb base (81). The circuit board (81′) is a narrow or elongated board inserted into the bulb base (81), which is different with the prior art U.S. Pat. No. 6,227,679 (Zhang et al.) issued on May 8, 2001. The Zhang patent discloses a circuit board located on the top of the base, in a vertical relation to the circuit board and base. Also, in the arrangement of Zhang, the LEDs are not located on one side of the circuit board but rather are applied on the circuit board with a certain angle to the circuit board surface. This is because Zhang does not realize that the distance between the LED tip and the top cover is way too close and it is impossible to eliminate the spot-light problem of an LED light beam therefore cannot get a good light performance on the bulb surface. The current invention uses the invention described in one of the copending applications listed above, of an LED night light with more than one optics means, to make the spot-light beam into an area-light by first optic means. By adding a second optics means, the light beams brightness will be very close at every point on the desired area or surface.

As shown in FIG. 13, LED (86) on is situated on the edge of the circuit board (81′) and positioned such that light beams from the LED are input to the first optics means (89) to cause the light beams to travel within the first optics medium (89). The top may use a dome shape design or a “V” shape design to collect light beams that hit the top area of the first optics medium. It will be appreciated that all equivalent treatments such as metallization of the top area or adding reflective arrangements within the first optics medium will be still fall within the scope of the invention. The LED device (13B) with screw type base can fit into a bulb night light's base socket (80) to replace the bulb and let the existing bulb night light become an LED night light without having to purchase a brand new unit to save money and change the big power consumption device into a lower power consumption device in seconds.

FIG. 14 show the Parent filing case for (# FF-4) (# FF-3) (# FF-2) (# FF-1) and (# II-2009) (# II-II) is the (# Q-07) as above discussed so not discuss more details here. Which also is parent filed case of (# R-2007) which is filed on same date of (# Q-2007) which is parent of division filed cases of (# R-1) (# R-2) (# R-3) (# R-4) (# R-5) (# R-6). From FIG. 30 show the background discussed the co-pending case (# R-6) (# R-5) (# R-4) (# R-2) (# R-2007) for LED night light has more than one optical element(s) as drawing FIG. 14 show details abstract which has 1^{st} (31) and 2^{nd} (30) optics-element(s). Where the said 1^{st} (31) optic-element(s) have at least one function(s) select from (i) to eliminate the at least one LED(s) (36) super brightness spot-light(s) to none super brightness spot-light(s) or very close even brightness, (ii) prevent people from touch LED(s) (31) or inner electric parts (34) on PCB, (3) allow the LED(s) light beam to passing through.

One of preferred embodiment, from FIG. 14 show the 1^{st} optics-element or optics-lens is one of tube construction. It is appreciated the 1^{st} optic-lens can be any construction such as dome (short of tube (30)), cone (sharp top of tube (30)), partial circle (half of tube (33)), curved piece (less than ½ tube (30)), flat piece; with or without air-bubble (33), reflectors (33), reflective, refractive, reflective and refractive optics-properties.

One of preferred embodiment, from FIG. 14 show the 2^{nd} optics-element or 2^{nd} optic-lens or 2^{nd} outer piece is one of detachable, separated piece which at least lack of one of (i) rear housing, (ii) side housing, (iii) rear and all sides housing; with or without at least one of (aa) U-shape or other-shape opening, (bb) built-in or add-on clipper, (cc) geometric shape clipper to clip-on or push-tight or assembled with base (2b) neck or groove or ditch (38).

One of preferred embodiment, from FIG. 14 show the said LED night light has built-in at least one of 2^{nd} LED(s) or more LED(s) to create at least one preferred light functions or performance for examples (i) color changing, (ii) color selection, (iii) brightness adjustable, (iv) fade-in or fade-out, or (v) other LED light function(s) or effect(s) available from marketplace while incorporate with at least one of (aaa) sensor (37), (bbb) IC on PCB, (ccc) switch(s), (ddd) wireless controller, (eee) slide switch.

From FIG. 14 also disclosure the said LED night light have at least one of additional functions, or features select from

(additional 1) outlet(s), or female receiving end(s), or terminal(s), or output(s), or port(s). as co-pending (# R-2007 U.S. patent Ser. No. 11/806,285 filed on May 31, 2007 same date of FIG. 30 which is (# Q-2007)).

(additional 2) motion/radar/photo/CDS sensor,

(additional 3) PIR sensor,

(additional 4) Air Freshener

(additional 5) second LED light or color LED light for area(s) or status indicator illumination.

(additional 6) bug repellent,

(additional 7) sonic repellent,

(additional 8) time piece,

(additional 9) supply AC or DC power device through outlet(s) or charger system(s)

(additional 9) any electric function(s) or features(s) combination from marketplace 1.

This arrangement solves the problem with the arrangement disclosed in the Zhang patent cited above that there is not enough space in a night light having the most popular dimensions to achieve a good area lighting effect. The most popular night light length is around 88 mm+/−50 mm (with base). The lens height is around 60 mm+/−30 mm (without base). The distance from the wall outlet cover to the highest point of the night light edge is around 35 mm+/−15 mm (from outlet cover surface). If placed in the same location as the existing bulb night light, the distance from the bulb socket to the wall outlet surface will be less than 35 mm. This distance from the wall to outside of the lens will only be less than 35 mm+/−15 mm. It is too short to change the spot-light effect of the LEDs into a surface or area lighting effect. The solution, as disclosed in the co-pending application is to use two optics means to get a good surface or area lighted effect. This will be the best because LED night light power consumption falls within the 0.3 W+/−100% per LED range, whereas a bulb night light falls within a 4 Watt+/−50% per bulb range. As a result, the LED night light will have a big power saving and help reduce monthly electric bills for the consumer.

The current invention also had below (29) features;
1. A multiple function LED night light,
comprising:
   at least one LED;
   at least one first optical element;
   at least one of built-in fixed and non-pivotal outer front lens or second optical element or exposed curved walls,
   wherein the at least one first optical element includes or is at least one of:
   (i) an elongate piece or unit or plate;
   (ii) a cone or dome or tube unit;
   (iii) an annular piece having at least one or plurality of (a) levels, (b) diameters, (c) rings, (d) one of reflective or refractive or reflective and refractive surface(s) or pieces;
   (iv) an at least partially cylindrical optical element or reflective piece,
   wherein the first optical element causes a spotlight beam from the at least one LED to spread out but not diffusion effects, incident on
   (a) an inner surface of the front lens or exposed curved wall(s) or second optical element surface, or
   (b) an inner wall of the night light; to provide illumination without super bright lighted spot(s) shown on at least one of (i) front lens or (ii) exposed curved wall(s) or (iii) second optical;
   wherein the night light further includes at least one electrical circuit connected to at least one prong to change electricity from a home wall AC power source to DC power source for the at least one LED and to at least one added function(s) or device(s), and
   wherein the at least one added function or device includes at least one of
   (1) color LED(s), or
   (2) a second sensor(s), or
   (3) a manual or electric switch(s) to select color, function(s), or brightness, or
   (4) Integrated circuit (IC), or
   (5) control system for brightness or color or function(s); to provide light functions that are in addition to the illumination without super bright lighted spot(s).
2. The multiple function LED night light as discussion 1, wherein the at least one LED(s) is one of a single-color LED(s), a plurality of colored LEDs, and a multiple color LED(s).
3. The multiple function LED night light as discussion 1, wherein the night light is arranged to accommodate at least one of an added female (i) adaptor, (ii) outlet unit, (iii) electric receiving structure; for supplying or charging power to the external electric product(s), or a surge protection related device(s).
4. The multiple function LED night light as discussion 1, wherein the at least one added function(s) or device(s) is selected from at least one of the following functions:
   A. At least one of back-up battery powered emergency light, power fail light, or flashlight function(s);
   B. At least one front or outer second optical element(s) or optical lens or exposed wall having arrangement or treatment select from; (i) translucent, (ii) whitened, (iii) textured, (iv) sand-blasted, (v) polished; to eliminate super bright lighted spot(s) illumination;
   C. At least one front or outer second optical element(s) or optical lens or exposed wall related to at least one LED(s) is; (aa) positioned or installed on contoured or side(s) of LED light, or (bb) is position front or top of 1^{st} optic element in preferred ring or square or geometric shaped which is one of injected piece or light block piece;
   D. At least one of indicator light function with preferred size, color(s), brightness for indicating status selected from; at least one charging status, power on/off status, surge system status, ground status, protected status, or switch location;
   E. At least one function(s) selected from; color changing, color selection, auto color changing, color freezing; controlled by an integrated circuit (IC).
5. The multiple function LED night light as discussion 1, wherein the at least one added-function device includes at least one of
   (i) conductive wire(s) or USB-wire has at least 2 male-plug(s) to input or output power; or
   (ii) female receptacle(s) or assembly to connect or receive at least one of electric wire(s) or male plug(s) of at least one or plurality external be-charged or be-supplied product(s).
6. A multiple function LED night light, comprising:
   at least one LED arranged to emit light through a first optical element to at least one of fixed (a) front optics-lens, (b) exposed wall(s), (c) second optical element(s).
   wherein the at least one first optical element includes or is at least one of:
   (A) an elongate piece or unit or plate;
   (B) a cone or dome or tube unit;
   (C) an annular unit having at least one of multiple (1) levels, (2) diameters, (3) rings, (4) reflective or refractive or reflective and refractive surface(s);
   (D) an at least partially cylindrical shape optics or reflective piece; or
   (E) a linear or elongated piece having at least one reflective or refractive surface; and
   wherein the first optical element causes at least one LED super bright lighted spot(s) to spread out but not diffusion effects, incident on
   (a) an inner surface of the front lens or second optical element; or surface(s) of exposed wall(s), or
   (b) an inner wall of the night light to provide illumination without bright lighted spot(s) shown on at least one of the front lens or-and exposed wall(s);
   wherein the night light further includes at least one electrical circuit connected to at least one prong to change AC electricity from a home power source to DC power for the at least one LED(s) and to at least one added function device.
7. A multiple function LED night light as discussion 6, wherein the at least one additional function or device or parts selected from; integrated circuit (IC), switch, second sensor(s) to control the LED(s), color(s), brightness, function(s) besides the non-bright lighted spot(s) illumination of LED light.
8. The multiple function LED night light as discussion 6, wherein the at least one added function device includes at least one switch having (1) multiple position, or (2) slide range, or (3) twist angle, or (4) variable resistance.
9. The multiple function LED night light as discussion 6, wherein the switch to select, change, set, or adjust at least one (i) brightness, (ii) color, (iii), motion sensor or photo sensor control functions, (iv) color auto or manual changing, (v) color holding or sequential changing, (vi) power fail light on/off/auto functions, (vii) power on or off, (viii) hi-low brightness, (ix) motion or dust-to-dawn function, or (x) reset upon detection of a power surge or short circuit.
10. An LED night light, comprising:
   at least one LED arranged to emit light through
      (i) a first optical element, and
      (ii) a second optical element which is a separate unit without a rear housing and that configured with a prong circuit-unit by at least one clip, or U-shape opening, or screw, or push-tight construction,
   wherein the first optical element is positioned in front or top or side of the at least one LED to prevent people from touching said at least one LED and other inner parts of the LED night light,
   wherein light beams exiting the first optical element are emitted to at least one of:
   (1) an inner surface of the second optical element;
   (2) an inner surface(s) of the night light;
   (3) a home wall having an outlet for receiving night light prong, the home wall being exposed because second optical element lack of a rear housing and home wall lighted by light beam exit from 1^{st} optical element,
   wherein the light beams exiting the first optical element go through at least one reflection, refraction, or reflection and refraction for multiple times between or within at least two of the
   (1) the surface of first optical element,
   (2) the inner surface the second optical element,
   (3) the inner surface of the night light,
   (4) the home wall; to provide illumination without super bright lighted spot(s),
   wherein the night light further includes at least one electrical circuit connected to at least one prong to change AC electricity from a home wall power source to DC power for the at least one LED for preferred illumination(s).
11. An LED night light as discussion 10, further including at least one of added function device is a non-wireless electrical device that is in addition to the at least one LED to provide a function other than said uniform brightness illumination or illumination without super bright lighted spot(s).
12. An LED night light as discussion 10, further including at least one electric circuit include electrical components selected from the group consisting of a resister, capacitor, switch, sensor, diode, inductor, transformer, and integrated circuit.
13. An LED night light as discussion 10, further including at least one electric circuit is configured to drive the at least one LED according to a predetermined timing, effects, and brightness and thereby provide said function other than said uniform brightness illumination or illumination without super bright lighted spot(s).
14. An LED night light, comprising:
   at least one LED arranged to emit light through
      (i) a first optical element, and
      (ii) a second optical element which is a separate or detachable unit without a rear housing and that configured with a prong circuit-unit by at least one clip, or U-shape opening, or screw, or push-tight construction,
   wherein the first optical element is positioned in front or top or side(s of the at least one LED to prevent people from touching said at least one LED and other inner parts of the LED night light,
   wherein light beams exiting the first optical element are emitted to at least one of:
   A. an inner surface of the second optical element;
   B. a surface of the night light;
   C. a home wall having an outlet for receiving night light prong, the home wall being exposed because second optical element lack of a rear housing and home wall lighted by light beam exit from 1^{st} optical element directly,
   wherein the light beams exiting the first optical element reflect, refract, or reflect and refract multiple times between or within at least two of the
   (1) the surface of first optical element,
   (2) the inner surface of second optical element,
   (3) the surface(s) of the night light, and
   (4) the home wall; to provide illumination without super bright lighted spot(s),
   wherein the night light further includes at least one electrical circuit connected to at least one prong to change AC electricity from a home wall power source to DC power for the at least one LED(s),
   wherein the night light further includes at least one of photo sensor or manual switch to turn on and turn off the light function(s).
15. A LED night light, comprising:
   at least one LED arranged to serve as a light
   source for:
(A) Providing illumination without bright lighted spots shown on at least one surface(s) of (i) outer front lens or (ii) exposed wall(s); wherein surface(s) being translucent, whitened, polished, textured, painted, or one of cartoon character design with glow light or light emit out from shape opening(s); Wherein the LED(s) light beam (i) go through, or (2) travel, or (3) reflected or refracted or reflected and refracted between or within; at least two of:
   (a1) a first optical lens that is one of a
      (a) tube,
      (b) dome,
      (c) cone,
      (d) partial cylinder,
      (e) elongate or curved shape plate or piece with at least one of reflective or refractive or reflected and refracted surfaces,
      (f) ring or annular construction unit(s) or lens(es) having more than one of surfaces or levels,
      (g) curved or partial cylinder reflect or refract piece; to eliminate LED(s) super bright lighted spot(s) but not diffusion effects;
   (a2) at least one surface(s) of front or outer optical lens or second optical element, or
      at least one surface(s) of exposed wall(s);
      having reflective, or refractive, or reflected and refracted properties; wherein light passable surface(s) having at least one white treatment, translucence, painting, polished or tooled texture;
   (a3) (i) inner surface of night light, or (ii) exposed wall(s); those light reflecting but no refractive, or LED light not able go through or
(B) a preferred size or color or brightness location or status indicator light positioned under or behind prismatic, treated, or translucent lens, or exposed to viewer; and
   at least one electrical circuit connected to at least one prong to change electricity from a home wall AC power source to DC power source for the at least one LED,
16. A LED night light as discussion 15, further has at least one added function(s) or device(s) which is at least one of an (1) an air-freshener, (2) a sound or audio device, (3) a bug repeller, (4) a time, date, or weather related device, and (5) a timer to set a sleep or wakeup light with an alarm setting device.
17. A LED night light as discussion 15, further has at least one additional function(s) or device(s) which is an electrically conductive receiving (i) end(s), (ii) adaptor(s), (iii) electrical power output or input device, or (iv) outlet device; to supply power to another product.
18. A LED night light as discussion 15, further has at least one additional function(s) or device(s) which is a second or group LED(s) or LED light with an integrated circuit (IC) to provide a multiple or changing or selecting color(s) light performance.
19. A LED night light as discussion 15, further has at least one additional function(s) or device(s) which is a second or group of LED(s) or LED light device incorporated with integrated circuit (IC) or sensor(s) or control circuit; to provide at least one of power fail light, emergency light or flashlight function; those have at least one of backup battery and that emits light from a second location different from the outer front lens.
20. A LED night light as discussion 15, further has additional function(s) or device(s) which is a second or group of LED(s) or LED light for indicator-light to show one of (1) charging status, or (2) location of night light, or (3) protected system status; with one or more than one colors to show pre-determined color(s).
21. A LED night light as discussion 15, further has at least one function(s) or device(s) which is a plurality of LEDs with an integrated circuit (IC) for multiple color or adjusting brightness or pre-determined LED light effects, at least including at least one of auto or manual changing light effects and color selection.
22. A LED night light as discussion 15, further has at least one function(s) or device(s) which is plurality of LEDs light effect(s) or illumination(s) shown on at least one (i) front or second optic-element(s), (ii) optics-lens having translucent, or whiten, or textures, (iii) built-in or exposed reflective walls.
23. A LED night light as discussion 15, further has at least one function(s) or device(s) which is one of surge, or short circuit, or overcharge, or overheat protection device, or another safety device, while LED night light having at least one AC outlet(s).
24. A LED night light as discussion 15, further has at least one function(s) or device(s) which is a switch having more than one position(s) or slide-range(s) or twist-angle(s) to set, adjust, or select at least one of colors, brightness, sound, time, auto changing color, color freezing, or an on/auto/off power function.
25. A multiple LED night light as discussion 15, further has at least one additional function(s) or device(s) which is an AC outlet with female receiving ends or ports
26. A LED night light as discussion 15, further has at least one additional function(s) or device(s) which is one of sensor system selected from a motion PIR sensor, a photosensor, or radar sensor.
27. A LED night light as discussion 15, further has at least one additional function(s) or device which is one of slide switch to set, adjust, or select at least one of variable brightness.
28. A function LED night light as discussion 15, further has at least one additional function(s) or device which is a switch to select at high or low brightness.
29. A LED night light with built-in AC-outlet(s), comprising;
   At least one LED(s) offer at least one of (1) area(s), (2) status indicating illumination for preferred size or area(s).
   At least one of Outlet built-in LED night light to deliver or supply AC power from LED night light male-prong through built-in female conductive (i) piece(s) or (ii) receiving port(s) those receive external AC operated electric product(s) male AC plug(s) or prong(s).
   Wherein, the LED night light has built-in AC-to-DC circuit which change home AC power to DC power for circuit to drive at least one LED(s), integrated circuit (IC), sensor(s), switch(s) to create pre-determined LED light function(s) or effect(s).

From above discussed and mentioned of preferred embodiments to show the scope of the current invention, it is appreciated that any alternative or equivalent functions of design still within the scope of the invention but not limited to all above discussion and mentioned details. The alternative or equivalent arrangement, process, installation or the like design, changes from the current invention still fall within the scope of the current invention.

1. A multiple function LED night light, comprising:
at least one LED;
at least one first optical element;
at least one of built-in fixed and non-pivotal outer front lens or second optical element or exposed curved walls,
wherein the at least one first optical element includes or is at least one of:
(i) an elongate piece or unit or plate;
(ii) a cone or dome or tube unit;
(iii) an annular piece having at least one or plurality of (a) levels, (b) diameters, (c) rings, (d) one of reflective or refractive or reflective and refractive surface(s) or pieces;
(iv) an at least partially cylindrical optical element or reflective piece,
wherein the first optical element causes a spotlight beam from the at least one LED to spread out but not diffusion effects, incident on
(a) an inner surface of the front lens or exposed curved wall(s) or second optical element surface, or
(b) an inner wall of the night light; to provide illumination without super bright lighted spot(s) shown on at least one of (i) front lens or (ii) exposed curved wall(s) or (iii) second optical;
wherein the night light further includes at least one electrical circuit connected to at least one prong to change electricity from a home wall AC power source to DC power source for the at least one LED and to at least one added function(s) or device(s), and
wherein the at least one added function or device includes at least one of
(1) color LED(s), or
(2) a second sensor(s), or
(3) a manual or electric switch(s) to select color, function(s), or brightness, or
(4) Integrated circuit (IC), or
(5) control system for brightness or color or function(s); to provide light functions that are in addition to the illumination without super bright lighted spot(s).

2. The multiple function LED night light as claim 1, wherein the at least one LED(s) is one of a single-color LED(s), a plurality of colored LEDs, and a multiple color LED(s).

3. The multiple function LED night light as claim 1, wherein the night light is arranged to accommodate at least one of an added female (i) adaptor, (ii) outlet unit, (iii) electric receiving structure; for supplying or charging power to the external electric product(s), or a surge protection related device(s).

4. The multiple function LED night light as claim 1, wherein the at least one added function(s) or device(s) is selected from at least one of the following functions:
A. At least one of back-up battery powered emergency light, power fail light, or flashlight function(s);
B. At least one front or outer second optical element(s) or optical lens or exposed wall having arrangement or treatment select from; (i) translucent, (ii) whitened, (iii) textured, (iv) sand-blasted, (v) polished; to eliminate super bright lighted spot(s) illumination;
C. At least one front or outer second optical element(s) or optical lens or exposed wall related to at least one LED(s) is; (aa) positioned or installed on contoured or side(s) of LED light, or (bb) is position front or top of 1^{st} optic element in preferred ring or square or geometric shaped which is one of injected piece or light block piece;
D. At least one of indicator light function with preferred size, color(s), brightness for indicating status selected from; at least one charging status, power on/off status, surge system status, ground status, protected status, or switch location;
E. At least one function(s) selected from; color changing, color selection, auto color changing, color freezing; controlled by an integrated circuit (IC).

5. The multiple function LED night light as claim 1, wherein the at least one added-function device includes at least one of
i. conductive wire(s) or USB-wire has at least 2 male-plug(s) to input or output power; or
ii. female receptacle(s) or assembly to connect or receive at least one of electric wire(s) or male plug(s) of at least one or plurality external be-charged or be-supplied product(s).

6. A multiple function LED night light, comprising:
at least one LED arranged to emit light through a first optical element to at least one of fixed (a) front optics-lens, (b) exposed wall(s), (c) second optical element(s).
wherein the at least one first optical element includes or is at least one of:
(A) an elongate piece or unit or plate;
(B) a cone or dome or tube unit;
(C) an annular unit having at least one of multiple (1) levels, (2) diameters, (3) rings, (4) reflective or refractive or reflective and refractive surface(s);
(D) an at least partially cylindrical shape optics or reflective piece; or
(E) a linear or elongated piece having at least one reflective or refractive surface; and
wherein the first optical element causes at least one LED super bright lighted spot(s) to spread out but not diffusion effects, incident on
(a) an inner surface of the front lens or second optical element; or surface(s) of exposed wall(s), or
(b) an inner wall of the night light to provide illumination without bright lighted spot(s) shown on at least one of the front lens or-and exposed wall(s);
wherein the night light further includes at least one electrical circuit connected to at least one prong to change AC electricity from a home power source to DC power for the at least one LED(s) and to at least one added function device.

7. A multiple function LED night light as claim 6, wherein the at least one additional function or device or parts selected from; integrated circuit (IC), switch, second sensor(s) to control the LED(s), color(s), brightness, function(s) besides the non-bright lighted spot(s) illumination of LED light.

8. The multiple function LED night light as claim 6, wherein the at least one added function device includes at least one switch having (1) multiple position, or (2) slide range, or (3) twist angle, or (4) variable resistance.

9. The multiple function LED night light as claim 6, wherein the switch to select, change, set, or adjust at least one (i) brightness, (ii) color, (iii), motion sensor or photo sensor control functions, (iv) color auto or manual changing, (v) color holding or sequential changing, (vi) power fail light on/off/auto functions, (vii) power on or off, (viii) hi-low brightness, (ix) motion or dust-to-dawn function, or (x) reset upon detection of a power surge or short circuit.

10. An LED night light, comprising:
at least one LED arranged to emit light through
i. a first optical element, and
ii. a second optical element which is a separate unit without a rear housing and that configured with a prong circuit-unit by at least one clip, or U-shape opening, or screw, or push-tight construction,
wherein the first optical element is positioned in front or top or side of the at least one LED to prevent people from touching said at least one LED and other inner parts of the LED night light,
wherein light beams exiting the first optical element are emitted to at least one of:
(A) an inner surface of the second optical element;
(A) an inner surface(s) of the night light;
(B) a home wall having an outlet for receiving night light prong, the home wall being exposed because second optical element lack of a rear housing and home wall lighted by light beam exit from 1^{st} optical element,
wherein the light beams exiting the first optical element go through at least one reflection, refraction, or reflection and refraction for multiple times between or within at least two of the
(1) the surface of first optical element,
(2) the inner surface the second optical element,
(3) the inner surface of the night light,
(4) the home wall; to provide illumination without super bright lighted spot(s),
wherein the night light further includes at least one electrical circuit connected to at least one prong to change AC electricity from a home wall power source to DC power for the at least one LED for preferred illumination(s).

11. An LED night light as claim 10, further including at least one of added function device is a non-wireless electrical device that is in addition to the at least one LED to provide a function other than said uniform brightness illumination or illumination without super bright lighted spot(s).

12. An LED night light as claim 10, further including at least one electric circuit include electrical components selected from the group consisting of a resister, capacitor, switch, sensor, diode, inductor, transformer, and integrated circuit.

13. An LED night light as claim 10, further including at least one electric circuit is configured to drive the at least one LED according to a predetermined timing, effects, and brightness and thereby provide said function other than said uniform brightness illumination or illumination without super bright lighted spot(s).

14. An LED night light, comprising:
at least one LED arranged to emit light through
i. a first optical element, and
ii. a second optical element which is a separate or detachable unit without a rear housing and that configured with a prong circuit-unit by at least one clip, or U-shape opening, or screw, or push-tight construction,
wherein the first optical element is positioned in front or top or side(s of the at least one LED to prevent people from touching said at least one LED and other inner parts of the LED night light,
wherein light beams exiting the first optical element are emitted to at least one of:
A. an inner surface of the second optical element;
B. a surface of the night light;
C. a home wall having an outlet for receiving night light prong, the home wall being exposed because second optical element lack of a rear housing and home wall lighted by light beam exit from 1^{st} optical element directly,
wherein the light beams exiting the first optical element reflect, refract, or reflect and refract multiple times between or within at least two of the
(1) the surface of first optical element,
(2) the inner surface of second optical element,
(3) the surface(s) of the night light, and
(4) the home wall; to provide illumination without super bright lighted spot(s),
wherein the night light further includes at least one electrical circuit connected to at least one prong to change AC electricity from a home wall power source to DC power for the at least one LED(s),
wherein the night light further includes at least one of photo sensor or manual switch to turn on and turn off the light function(s).

15. A LED night light, comprising:
at least one LED arranged to serve as a light source for:
(C) Providing illumination without bright lighted spots shown on at least one surface(s) of (i) outer front lens or (ii) exposed wall(s); wherein surface(s) being translucent, whitened, polished, textured, painted, or one of cartoon character design with glow light or light emit out from shape opening(s);
Wherein the LED(s) light beam (i) go through, or (2) travel, or (3) reflected or refracted or reflected and refracted between or within; at least two of:
(a1) a first optical lens that is one of a
(a) tube,
(b) dome,
(c) cone,
(d) partial cylinder,
(e) elongate or curved shape plate or piece with at least one of reflective or refractive or reflected and refracted surfaces,
(f) ring or annular construction unit(s) or lens(es) having more than one of surfaces or levels,
(g) curved or partial cylinder reflect or refract piece; to eliminate LED(s) super bright lighted spot(s) but not diffusion effects;
(a2) at least one surface(s) of front or outer optical lens or second optical element, or
at least one surface(s) of exposed wall(s);
having reflective, or refractive, or reflected and refracted properties;
wherein light passable surface(s) having at least one white treatment, translucence, painting, polished or tooled texture;
(a3) (i) inner surface of night light, or (ii) exposed wall(s); those light reflecting but no refractive, or LED light not able go through
or
(B) a preferred size or color or brightness location or status indicator light positioned under or behind prismatic, treated, or translucent lens, or exposed to viewer; and
at least one electrical circuit connected to at least one prong to change electricity from a home wall AC power source to DC power source for the at least one LED,

16. A LED night light as claim 15, further has at least one added function(s) or device(s) which is at least one of an (1) an air-freshener, (2) a sound or audio device, (3) a bug repeller, (4) a time, date, or weather related device, and (5) a timer to set a sleep or wakeup light with an alarm setting device.

17. A LED night light as claim 15, further has at least one additional function(s) or device(s) which is an electrically conductive receiving (i) end(s), (ii) adaptor(s), (iii) electrical power output or input device, or (iv) outlet device; to supply power to another product.

18. A LED night light as claim 15, further has at least one additional function(s) or device(s) which is a second or group LED(s) or LED light with an integrated circuit (IC) to provide a multiple or changing or selecting color(s) light performance.

19. A LED night light as claim 15, further has at least one additional function(s) or device(s) which is a second or group of LED(s) or LED light device incorporated with integrated circuit (IC) or sensor(s) or control circuit; to provide at least one of power fail light, emergency light or flashlight function; those have at least one of backup battery and that emits light from a second location different from the outer front lens.

20. A LED night light as claim 15, further has additional function(s) or device(s) which is a second or group of LED(s) or LED light for indicator-light to show one of (1) charging status, or (2) location of night light, or (3) protected system status; with one or more than one colors to show pre-determined color(s).

21. A LED night light as claim 15, further has at least one function(s) or device(s) which is a plurality of LEDs with an integrated circuit (IC) for multiple color or adjusting brightness or pre-determined LED light effects, at least including at least one of auto or manual changing light effects and color selection.

22. A LED night light as claim 15, further has at least one function(s) or device(s) which is plurality of LEDs light effect(s) or illumination(s) shown on at least one (i) front or second optic-element(s), (ii) optics-lens having translucent, or whiten, or textures, (iii) built-in or exposed reflective walls.

23. A LED night light as claim 15, further has at least one function(s) or device(s) which is one of surge, or short circuit, or overcharge, or overheat protection device, or another safety device, while LED night light having at least one AC outlet(s).

24. A LED night light as claim 15, further has at least one function(s) or device(s) which is a switch having more than one position(s) or slide-range(s) or twist-angle(s) to set, adjust, or select at least one of colors, brightness, sound, time, auto changing color, color freezing, or an on/auto/off power function.

25. A multiple LED night light as claim 15, further has at least one additional function(s) or device(s) which is an AC outlet with female receiving ends or ports

26. A LED night light as claim 15, further has at least one additional function(s) or device(s) which is one of sensor system selected from a motion PIR sensor, a photosensor, or radar sensor.

27. A LED night light as claim 15, further has at least one additional function(s) or device which is one of slide switch to set, adjust, or select at least one of variable brightness.

28. A function LED night light as claim 15, further has at least one additional function(s) or device which is a switch to select at high or low brightness.

29. A LED night light with built-in AC-outlet(s), comprising;
At least one LED(s) offer at least one of (1) area(s), (2) status indicating illumination for preferred size or area(s).
At least one of Outlet built-in LED night light to deliver or supply AC power from LED night light male-prong through built-in female conductive (i) piece(s) or (ii) receiving port(s) those receive external AC operated electric product(s) male AC plug(s) or prong(s).
Wherein, the LED night light has built-in AC-to-DC circuit which change home AC power to DC power for circuit to drive at least one LED(s), integrated circuit (IC), sensor(s), switch(s) to create pre-determined LED light function(s) or effect(s).
